(19) United States
(12) Patent Application Publication
(10) Pub. No.: US 2001/0042764 A1
(43) Pub. Date: Nov. 22, 2001

(54) Dispenser for an oil container

(76) Inventor: John Baldwin, Rockvale, TN (US)

Correspondence Address: MARK A OATHOUT, 3730 KIRBY DRIVE, SUITE 830, HOUSTON, TX, 77098

(21) Appl. No.: 09/813,541

(22) Filed: Mar. 21, 2001

Related U.S. Application Data
(60) Provisional application No. 60/191,934, filed on Mar. 24, 2000.

(51) Int. Cl. B67D 3/00; B67D 5/06

(52) U.S. Cl. 222/513; 222/514

(57) ABSTRACT

A device for dispensing oil from an oil container has a fill tube, a spring mounted on the fill tube, a cover mounted on the fill tube and against the spring and two O-rings. The fill tube is closed on top but has one or more openings near the end.

This application is based upon and claims the benefit of U.S. provisional application No. 60/191,934 filed Mar. 24, 2000.

### BACKGROUND

There are a variety of problems which can be encountered when dispensing oil or the like from a commercial oil container into an car, truck, motorcycle, lawnmower, etc. These problems are exacerbated when the fill tube of, for example, a car is in a position which is cumbersome to access; when oil is spilled during the filling process; and when only a partial container is used.

### SUMMARY OF THE INVENTION

A device for dispensing oil from an oil container has a fill tube, a spring mounted on the fill tube, a cover mounted on the fill tube and against the spring and two O-rings. The fill tube is closed on top but has one or more openings near the end.

Certain embodiments of this invention are not limited to any particular individual features disclosed, but include combinations of features distinguished from the prior art in their structures and functions. Features of the invention have been broadly described so that the detailed descriptions that follow may be better understood, and in order that the contributions of this invention to the arts may be better appreciated. There are, of course, additional aspects of the invention described below. These may be included in the subject matter of the claims to this invention. Those skilled in the art who have the benefit of this invention, its teachings, and suggestions will appreciate that the conceptions of this disclosure may be used as a creative basis for designing other structures, methods and systems for carrying out and practicing the present invention. The claims of this invention are to be read to include any legally equivalent devices or methods which do not depart from the spirit and scope of the present invention.

The present invention recognizes, addresses and meets the previously-mentioned preferences or objectives in its various possible embodiments and equivalents thereof. To one of skill in this art who has the benefit of this invention's realizations, teachings, disclosures, and suggestions, other purposes and advantages will be appreciated from the following description and the accompanying drawings. The detail in the description is not intended to thwart this patent's object to claim this invention no matter how others may later disguise it by variations in form or additions of further improvements. These descriptions illustrate certain preferred embodiments and are not to be used to improperly limit the scope of the invention which may have other equally effective or legally equivalent embodiments.

### BRIEF DESCRIPTION OF THE DRAWINGS

FIG. 1 is an elevational view of the invention partially in cross section.

FIG. 2 is an elevational view of the fill tube partially in cross section.

FIG. 3 is an elevational view of the cover partially in cross section.

FIG. 4 is an perspective view of the invention in the sealed position.

FIG. 5 is an perspective view of the invention in the flow or discharge position.

### DETAILED DESCRIPTION

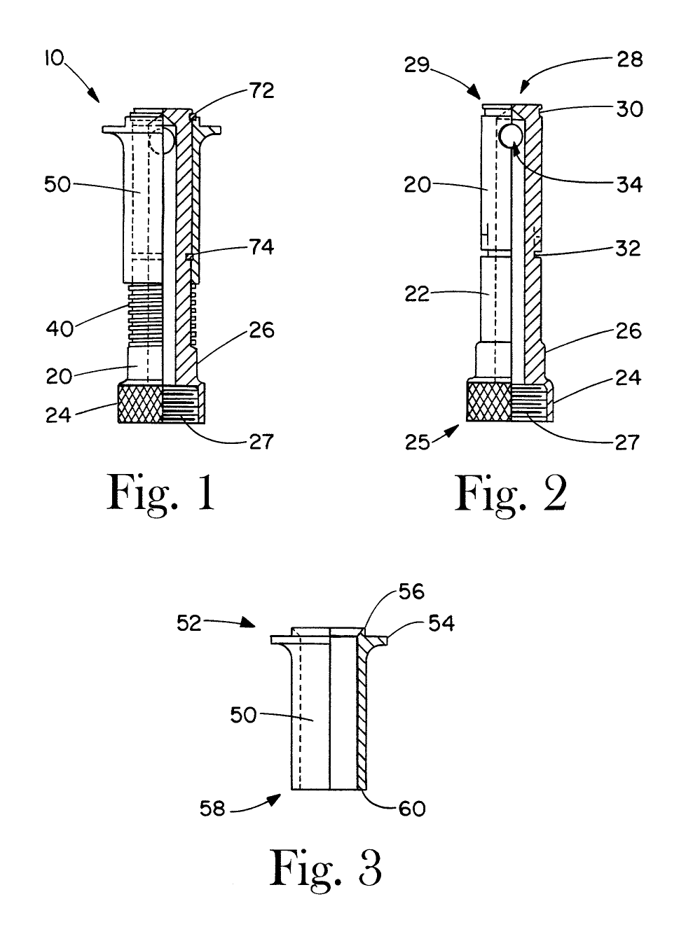

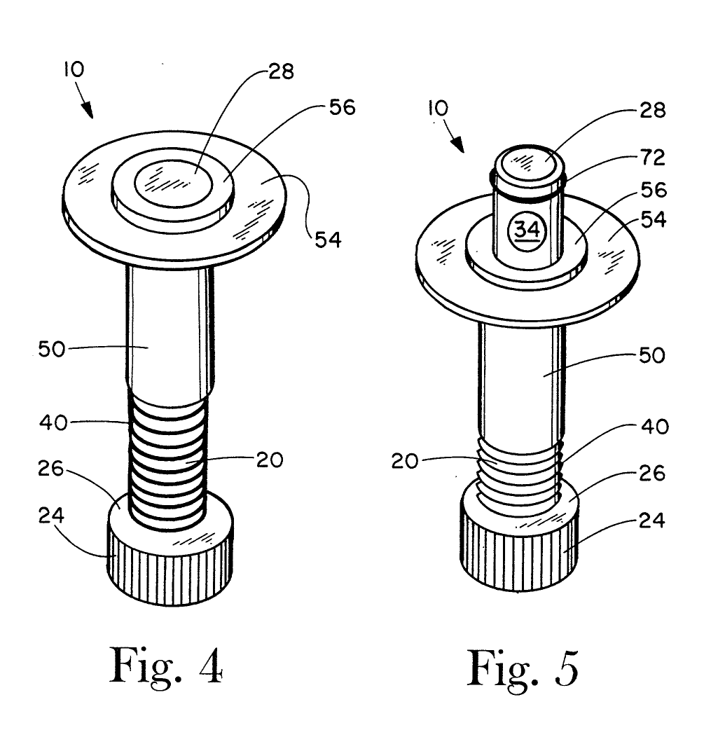

FIGS. 1-5 represent a dispensing device 10 for dispensing oil from an oil container (not shown) into an automobile, tractor, lawnmower, etc. The device generally includes a fill tube 20, a spring 40 mounted on the fill tube 20, a cover 50 mounted on the fill tube 20 and against the spring 40, and two O-rings 72, 74.

The fill tube 20 is preferably a straight tube with a cylindrical wall 22 which defines a flow passage through the interior. The fill tube 20 has a connector 24 at one end 25 adapted for attaching the device 10 onto the open mouth of a plastic oil container (or any other suitable container, e.g. a gas can, a transmission fluid container, etc.) preferably via threading 27. The fill tube 20 also has a collar 26 at this end 25 (which as shown may be contiguous with the connector 24) serving as a seat for the compression spring 40. The fill tube 20 is closed on top of the other end 29, e.g. with a snap-in-top or other suitable enclosure 28 (the fill tube 20 may be manufactured or molded with an enclosed end), to prevent flow out of the end. The fill tube 20 preferably has an O-ring groove 30 proximate the end 29. There is a second O-ring groove 32 between and preferably intermediate the ends 25, 29 of the fill tube 20. A first and a second O-ring 72, 74, respectively, are mounted in the O-ring grooves 30, 32. The first O-ring 72 may be larger than the second O-ring 74 for retaining the cover 50 on the fill tube 20 (or the snap-in-top 28 may have a larger diameter than the fill tube 20). The fill tube 20 also has one or more openings 34 through the cylindrical wall 22 near the other end 29 between the O-ring grooves 30, 32.

The compression spring 40 is preferably a helical metal spring or like urging device.

The cover 50 has a cylindrical passage with an inner diameter greater than the outer diameter of the fill tube 20. The length of the cover 50 is shorter than the length of the fill tube 20. The upper end 52 of the cover 50 has a flanged surface 54 or the like and a protuberant lip 56 extending in the fill tube's axial direction from the flanged surface 54. The flanged surface 54 and the protuberant lip 56 are both for contacting and pushing against a surface (not shown), such as, for example, a mouth of a crank case, a hand, etc. The lower end 58 of the cover 50 must be sufficiently thick or a shoulder 60 to engage the compression spring 40 and bias the cover 50 in the direction of the end 29 of the device. When the cover 50 is biased toward the end 29 of the device, the cover 50 and the two O-rings 72, 74 create a seal around the opening(s) 34 to prevent leakage, spillage and/or pouring. Hence, when the device 10 is attached to an oil container and turned upside down, oil will not be discharged from the device unless the cover 50 is moved as more fully discussed below.

Once the device 10 is attached to an oil container and it is time to dispense oil into the crank case of an engine, the flanged surface 54 on the cover 50 is placed against the mouth of the opening of the device to be filled (not shown). Next, pressure is applied to overcome the bias of the spring 40 and to insert the fill tube 20 into the mouth of the device to be filled. As the fill tube 20 slides through the cover 50, the discharge opening(s) 34 in the fill tube 20 emerge(s) beyond the first O-ring 72 and the end of the cover 50. Then, the fill tube 20 is free from sealing engagement with the cover 50 and oil is free to flow from the oil container, through the fill tube 20, out the discharge opening(s) 34 and into the device to be filled, e.g., the crank case of the engine.

The device could be made with the O-rings replaced by some other sealing mechanism, such as, for example, two pliable plastic ridges (not shown) molded inside the cover 50 such that the ridges will interfere with the fill tube 20 when the cover is mounted on the fill tube. The device may also include a vent hole (not shown) to be used while pouring oil or the like.

The device may have the following dimensions, for example: a 4.5 inch long fill tube, a 2.375 inch long cover, a 0.875 inch inner diameter of the cover, a 0.870 inch outer diameter of the fill tube, and a 0.021 inch stainless steel spring with a 0.878 inch inner diameter having a free length of 2.3 inches and rated at 4.3 lbs./in. The first and second O-ring grooves are approximately 2 inches apart.

Therefore, it is seen that the present invention is well adapted to carry out the objectives and obtain the ends set forth.

Certain changes can be made in the subject matter without departing from the spirit and the scope of this invention. It is realized that changes are possible within the scope of this invention and it is further intended that each element or step recited in any claims is to be understood as referring to all equivalent elements or steps. The claims are intended to cover the invention as broadly as legally possible in whatever form it may be utilized.

What is claimed is:

1. An apparatus for dispensing a fluid from a container, comprising:
a fill tube having a connector at a first end, and an enclosure on a second end, said fill tube defining a first O-ring groove proximate the second end, a second O-ring groove between the first and second ends and an opening through said fill tube between the first and the second O-ring grooves;
a first O-ring mounted in the first O-ring groove;
a second O-ring mounted in the second O-ring groove; and
a cover mounted over said fill tube and against the spring, wherein said cover engages the first and the second O-rings.

2. The apparatus according to claim 1, further including a spring mounted on said fill tube against the connector.

3. The apparatus according to claim 1, wherein said cover has a flanged surface at one end.

4. The apparatus according to claim 3, wherein said cover further includes a protuberant lip extending from said flanged surface.

5. The apparatus according to claim 1, wherein the enclosure comprises a snap-in-top.

6. The apparatus according to claim 1, wherein said cover has an inner diameter which is greater than an outer diameter of said fill tube.

7. The apparatus according to claim 1, wherein the first and second O-ring grooves are spaced apart by approximately 2 inches.

8. An apparatus for dispensing a fluid from a container, comprising:
a fill tube having a connector at a first end, and an enclosure on a second end, said fill tube defining a first O-ring groove proximate the second end, a second O-ring groove between the first and second ends and an opening through said fill tube between the first and the second O-ring grooves;
a first O-ring mounted in the first O-ring groove;
a second O-ring mounted in the second O-ring groove;
a spring mounted on said fill tube against the connector; and
a cover mounted over said fill tube and against the spring, wherein said cover engages the first and the second O-rings and has a flanged surface at one end.

9. The apparatus according to claim 8, wherein said cover further includes a protuberant lip extending from said flanged surface.

10. The apparatus according to claim 8, wherein the enclosure comprises a snap-in-top.

11. The apparatus according to claim 8, wherein said cover has an inner diameter which is greater than an outer diameter of said fill tube.

12. The apparatus according to claim 8, wherein the first and second O-ring grooves are spaced apart by approximately 2 inches.

13. An apparatus for dispensing a fluid from a container, comprising:
a fill tube having a connector at a first end including a means for attachment to the container, and a snap-in-top on a second end, said fill tube defining a first O-ring groove proximate the first end, a second O-ring groove intermediate the first and the second ends and an opening through said fill tube between the first and the second O-ring grooves;
a first O-ring mounted in the first O-ring groove;
a second O-ring mounted in the second O-ring groove;
a spring mounted on said fill tube against the connector; and
a cover mounted over said fill tube and against the spring, wherein said cover has an inner diameter which is greater than an outer diameter of said fill tube and engages the first and the second O-rings, and said cover includes a flanged surface at one end and a protuberant lip extending from said flanged surface.

14. The apparatus according to claim 13, wherein the first and second O-ring grooves are spaced apart by approximately 2 inches.
